(19) United States
(12) Patent Application Publication
(10) Pub. No.: US 2008/0018641 A1
(43) Pub. Date: Jan. 24, 2008

(54) DISPLAY CONFIGURED FOR VARYING THE APPARENT DEPTH OF SELECTED PIXELS

(76) Inventors: Randall B. Sprague, Carnation, WA (US); Hakan Urey, Istanbul (TR)

Correspondence Address: Michael G. Pate, Esq.;DORSEY & WHITNEY LLP, Suite 3400, 1420 Fifth Avenue, Seattle, WA, 98101, US

(21) Appl. No.: 11/683,386

(22) Filed: Mar. 7, 2007

Related U.S. Application Data
(60) Provisional application No. 60/780,454, filed on Mar. 7, 2006.

(51) Int. Cl. G06T 17/00

(52) U.S. Cl. 345/419

(57) ABSTRACT

Apparatuses and methods for scanned and non-scanned light display systems are disclosed. A scanned light display system includes a collimating element configured to at least partially collimate light, and a first and at least a second set of pixel sources. The first set of pixel sources may be offset a fixed distance from the at least a second set of pixel sources so that light provided by the pixel sources of the first set and light provided by the pixel sources of the at least a second set is at least partially collimated by the collimating element to different extents to provide pixels having different apparent depths in an image. In other embodiments, the display system may be a scanned or non-scanned display that may relatively move the pixel source and the collimating element to vary the apparent depth of selected pixels.

### CROSS-REFERENCE TO RELATED APPLICATION

This application claims the benefit of U.S. provisional application No. 60/780,454, filed Mar. 7, 2006, the contents of which are incorporated herein in its entirety.

### TECHNICAL FIELD

This invention relates to image display systems, such as scanned and non-scanned light displays, configured to selectively vary the accommodation of pixels in a displayed image.

### BACKGROUND

A variety of techniques are available for providing visual displays of still or video images to a user. One form of display is a scanned light display. In one example of a scanned light display, a scanning light source outputs a beam of coherent light that is reflected by a mirror in a MEMS scanner onto a viewer's retina. The scanned light enters the viewer's eye through the viewer's pupil and is directed onto the retina by the cornea and lens. The intensity of the light from the light source is modulated as the beam is scanned horizontally and vertically so that the viewer perceives an image. In other examples, the scanning source may include one or more modulated light emitters that are rotated through an angular sweep to scan the light onto the viewer's retina.

Many currently available displays do not require scanning light to form the image. One example of one non-scanned light display is a conventional liquid crystal display (LCD), which are used in a variety of applications, such as laptop computers, digital clocks, and a number of other consumer products.

Regardless of whether the display is a scanned light display or a non-scanned light display, in order to produce a more realistic image having the appearance of representing three dimensions (3D), a number of physiological depth cues may be presented to the eye-brain system of the viewer when producing the 3D image.

Manipulation of these physiological depth cues for forming the displayed image not only enables providing a more realistic 3D image, but can prevent the viewer from developing eye strain and/or nausea that can occur when viewing a prior art 3D image.

### SUMMARY

Apparatuses and methods for scanned and non-scanned light display systems are disclosed. The displays disclosed herein enable varying the apparent depth of selected pixels to define a 3D image. The displays may employ various pixel sources for providing light such as, for example, a surface-emitting LED, an organic LED (OLED), an edge emitting light emitting diode, a laser diode, a diode-pumped solid state (DPSS) laser, a portion of photoluminescent material, a reflector, a fiber-optic source, an LCD panel, or another suitable light source.

In one aspect, a scanned light display system for providing an image includes a collimating element, such as a curved mirror, configured to at least partially collimate light, and a first and at least a second set of pixel sources that may be positioned in front of the collimating element. The first set of pixel sources may be offset a fixed distance from the at least a second set of pixel sources so that light provided by the pixel sources of the first set of pixel sources and light provided by the pixel sources of the at least a second set of pixel sources is at least partially collimated by the collimating element to different extents to provide pixels having different apparent depths in the image. The scanned light display system further includes an actuator operable to move the collimating element and the first and at least a second set of pixel sources relative to each other in order to scan the at least partially collimated light to form the image.

In another aspect, a scanned light display system for providing an image includes a pixel source operable to provide diverging light, and a curved mirror positioned to receive at least a portion of the light and configured to at least partially collimate the received light. The scanned light display system further includes a first actuator operable to relatively move the pixel source and the curved mirror in at least one of a direction toward each other and a direction away from each other so that light provided by the pixel source is at least partially collimated by the curved mirror to different extents depending upon the location of the pixel source. By controlling the position from which the pixel source provides light, pixels having different apparent depths may be generated in the image. A second actuator is also operable to relatively move the curved mirror and the pixel source in order to scan the received light to form the image.

In yet another aspect, a non-scanning display system for providing an image includes a collimating element configured to at least partially collimate light and a plurality of pixels sources that may be positioned in front of the collimating element. Each of the pixel sources corresponds to a pixel of the image. The display further includes an actuator operable to relatively move the plurality of pixel sources and the collimating element in at least one of a direction toward each other and a direction away from each other so that light provided by the pixel source is at least partially collimated by the collimating element to different extents depending upon the location of the pixel source to provide pixels having different apparent depths in the image.

### BRIEF DESCRIPTION OF THE DRAWINGS

FIG. 1 is a schematic cross-sectional view of scanned light display having a light source including a plurality of linear arrays of light emitters positioned at different distances from a curved mirror that reflects the light emitted therefrom onto a viewer's pupil according to one embodiment.

FIG. 2 is schematic isometric view of the light source shown in FIG. 1 according to one embodiment.

FIG. 3 is an isometric view of a scanned light display configured to be worn on the head of a viewer according to one embodiment.

FIG. 4 is a top cross-sectional view of the scanned light display of FIG. 3.

FIG. 5 is a schematic top view of a scanned light display having a light source including a plurality of optically addressable linear photoluminescent arrays positioned at different distances from a curved mirror according to one embodiment.

FIG. 6 is a schematic isometric view of the light source having the plurality of linear photoluminescent arrays shown in FIG. 5 according to one embodiment.

FIG. 7 is a schematic cross-sectional view of a scanned light display having a light source in which the position of the light source relative to a curved mirror may be altered to vary the apparent depth of selected pixels of an image displayed to a viewer according to one embodiment.

FIGS. 8A and 8B are schematic cross-sectional views of an actuator having a cantilevered beam that is configured to modulate the position of the light sources of the display shown in FIG. 7 according to one embodiment.

FIG. 8C is a schematic isometric view of an actuator having a plurality of cantilever beams that each have a light emitter positioned on an end thereof according to one embodiment.

FIG. 9 is a schematic cross-sectional view of a scanned light display employing a light source having a linear photoluminescent array in which the position of the linear photoluminescent array relative to a curved mirror may be altered to vary the apparent depth of selected pixels of an image displayed to a viewer according to one embodiment.

FIG. 10 is a schematic cross-sectional view of another embodiment of a scanned light display employing a light source having a linear photoluminescent array in which the position of the linear photoluminescent array relative to a curved mirror may be altered to vary the apparent depth of selected pixels of an image displayed to a viewer.

FIG. 11 is a schematic cross-sectional view of a non-scanned display having a fully populated array of light sources in which each light source corresponds to a pixel of the displayed image.

FIG. 12 is a schematic plan view of the array of light sources of FIG. 11.

FIG. 13 is a simplified block diagram of a display system that may be used with the displays of FIG. 1-12 according to one embodiment.

FIG. 14 is a block diagram of a scanned light display system used in conjunction with, or as a subsystem of a still or video camera or other stored image viewing system according to one embodiment.

FIG. 15 is a block diagram of a media viewer capable of rendering still and/or video images to a user from a streaming and/or wireless media source according to one embodiment.

### DETAILED DESCRIPTION OF THE EMBODIMENTS

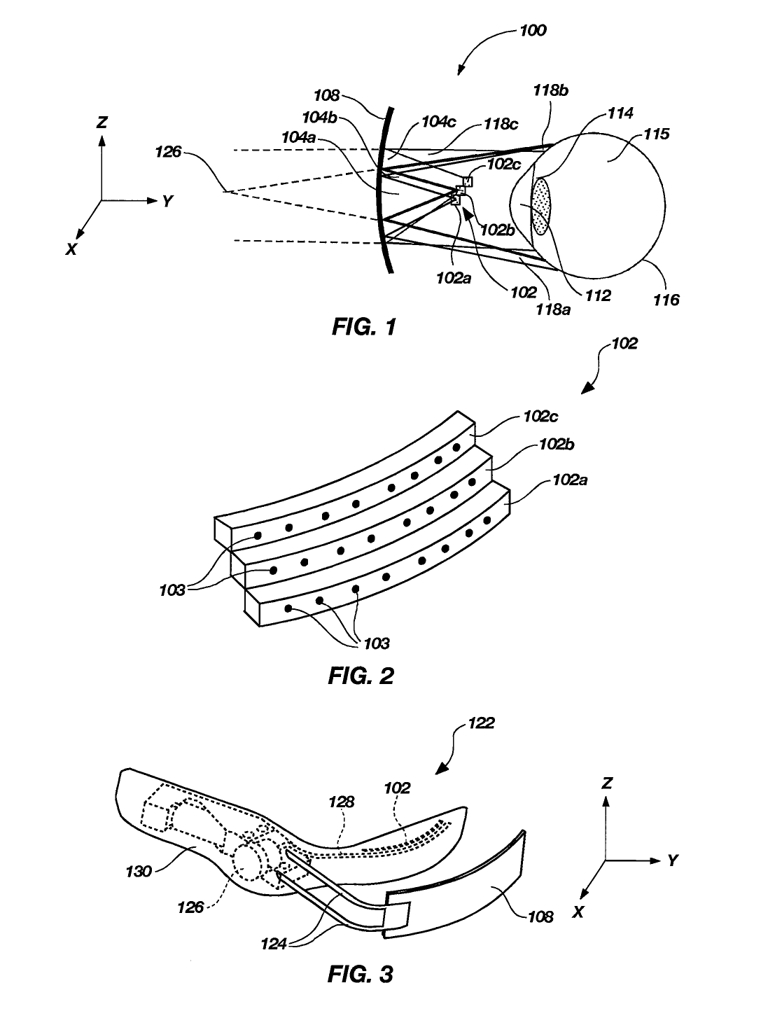

Apparatuses and methods for scanned and non-scanned light displays configured for varying the apparent depth or accommodation of selected pixels that define a 3D image in a given image frame are disclosed. Many specific details of certain embodiments are set forth in the following description and in FIGS. 1 through 15 in order to provide a thorough understanding of such embodiments. One skilled in the art, however, will understand that there may be additional embodiments, or that the disclosed embodiments may be practiced without several of the details described in the following description.

The embodiments disclosed herein show the displays being used only with one eye and a single ocular. However, the displays may be configured as a binocular display using two oculars and two image generators to provide left and right images to respective eyes, in conjunction, if desired, with the display being further configured for tracking movement of the left and right eye pupils to account for convergence and tracking head movement to account for the viewer's head movement to provide a more realistic 3D stereo image to the viewer.

FIG. 1 shows a scanned light display 100 configured to vary the apparent depth of selected pixels in an image displayed to a viewer according to one embodiment. In the display 100, the focal length of beams of light scanned across the viewer's retina to create the image may be selectively varied by electronically selecting which particular light emitters of a light source emit light. The light source includes a plurality of sets of light emitters with each set being located at a fixed distance from a curved mirror and each of the light emitters corresponding to particular pixels in the image. This enables creating a more realistic 3D image for the viewer.

The display 100 includes a light source 102 having a plurality of linear arrays of light emitters 102a-102c with each of the linear arrays 102a-102c positioned a fixed distance from the curved mirror 108. Each of the linear arrays 102a-102c include a set of light emitters (not shown in FIG. 1, see FIG. 2) that are operable to emit diverging light 104a-104c having a large numerical aperture, although only three cones of light 104a-104c are shown in FIG. 1, other embodiments may include four or more cones of light. The light 104a-104c emitted from corresponding light emitters of the linear arrays 102a-102c is reflected by the relatively large curved mirror 108 (e.g., a spherical mirror). The curved mirror 108 and the light source 102 are operable to be moved relative to each other in order to scan the light reflected from the curved mirror 108 in one or more directions. One suitable actuator for scanning the curved mirror 108 is a magnetically driven actuator that is disclosed in U.S. patent application Ser. No. 11/078,970, entitled SCANNED LIGHT DISPLAY SYSTEM USING LARGE NUMERICAL APERTURE LIGHT SOURCE, METHOD OF USING SAME, AND METHOD MAKING SCANNING MIRROR ASSEMBLIES, filed on Mar. 9, 2005, the disclosure of which is incorporated herein by reference. A field-of-view visible to the viewer is formed on the curved mirror 108 as it sweeps the light 104a-104c, while the intensity and focal length of the light 104a-104c are modulated to sequentially create an array of picture elements. If the curved mirror 108 is semi-transparent or another suitable optical design is selected such as an approach using a semi-transparent relay mirror, the display 100 may be configured as a see-through display in which a background image positioned behind the curved mirror 108 is visible.

The curved mirror 108 is configured to nearly or substantially collimate light emitted from the light emitters of the linear arrays 102a-102c into a beam that may be received by a pupil 112 of a viewer's eye 115 when a light emitter of the linear arrays 102a-102c is positioned, respectively, nearly on or on the focal surface of the curved mirror 108. The light emitters of the linear arrays 102a-102c positioned closer to the curved mirror 108 than the focal surface of the curved mirror 108, produce beams reflected from the curved mirror 108 that are divergent. Light emitters of the linear array 102c positioned on the focal surface of the curved mirror 108 produce beams reflected from the curved mirror 108 that are collimated. This is best shown in FIG. 1, where light 104c emitted from a light emitter of the linear array 102c positioned on or proximate the focal surface of the curved mirror 108 is collimated into a substantially fully collimated beam 118c, while the light 104b emitted from a light emitter of the linear array 102b located closer to the curved mirror 108 than the linear array 102c is reflected as a divergent beam 118b. Lens 114 of the viewer's eye 115 then focuses the one or more beams 118a-118c reflected from the curved mirror 108 onto the viewer's retina 116 according to the viewer's depth accommodation. The degree of collimation provided by the curved mirror 108 may correspond to an apparent image distance or depth. For example, the apparent image location of the pixel or pixels provided by the partially collimated beam 118b corresponds to a first distance represented by the point 120 and the pixel or pixels provided by the collimated beam 118c corresponds to a greater apparent image distance, commonly referred to as infinity.

The curved mirror 108 should be relatively large to allow the beams 118a-118c to sweep across the retina 116 during scanning, while keeping a portion of the beams 118a-118c aligned with the pupil 112. By making the diameter of the curved mirror 108 relatively large, the apparent position of the light source moves across the curved mirror 108 as it scans, creating the impression of an array of picture elements. Furthermore, by making the diameter of the curved mirror 108 relatively large, there is a sufficient portion of the beams 118a-118c to fill the viewer's pupil 112, even at extreme angles.

Although the various embodiments described throughout this disclosure have been described as using a curved mirror, according to alternative embodiments, a diffractive optical element may be substituted for the curved mirror described herein. It will be understood that, as modifications to the mirror shape such as adaptation to a Fresnel type mirror remain within the scope, so too does the adaptation to a diffractive element of arbitrary shape. In the interest of brevity and clarity, the term “curved mirror” will be understood to include such alternative mirror types.

Furthermore, while various embodiments refer to a light emitter 103 substantially on the focal surface of a curved mirror 108 corresponding to a pixel placement at infinity, according to alternative embodiments, the relative positions of light emission may vary. For example, the particular placement of light emission may be varied to be nearer than the focal surface to adjust the apparent maximum image distance to a point nearer than infinity. Similarly, the particular placement of light emission may be varied to be nearer than or farther than the focal surface to adjust the image to compensate for eyesight deficiencies of the viewer and/or to compensate for viewing conditions, such as when superimposing an image in a telescopic, microscopic, etc. view.

Turning now to FIG. 2, one embodiment for the light source 102 is shown. The light source 102 includes a plurality of linear array of light emitters 102a-102c configured in a “stair step” arrangement. The light source 102 may be relatively thin so that the viewer's visual field is not significantly obstructed. While only three linear arrays 102a-102c are shown, more or less than three linear arrays may be used. Each of the linear arrays 102a-102c includes a set of light emitters 103 operable to emit diverging light. Thus, in the configuration of the light source 102, each of the light emitters 103 in respective linear arrays 102a-102c are offset from each other by a fixed distance. In one embodiment, each of the linear arrays 102a-102c is fully populated with light emitters 103 so that there is one light emitter 103 in each of the linear arrays 102a-102c for every pixel in a horizontal pixel line of the image. The light emitters 103 of the linear array 102c are positioned on or proximate the focal surface of the curved mirror 108 and the light emitters 103 of the linear arrays 102a and 102b are positioned off of the focal surface of the curved mirror 108. Thus, pixels provided by light emitted from the light emitters 103 of the linear array 102a and reflected from the curved mirror 108 have an apparent image distance that is closest to the viewer, while pixels provided by light emitted from the light emitters 103 of the linear array 102b and reflected from the curved mirror 108 have an apparent image distance that is relatively farther away. Pixels provided by light emitted from the light emitters 103 of the linear array 102c and reflected from the curved mirror 108 have an apparent image distance that is relatively farthest away to the viewer because the light emitters 103 of the linear array 102c are farthest from the curved mirror 108 (e.g., positioned on or proximate the focal surface of the curved mirror 108).

The light emitters 103 may be referred to as Lambertian light sources, though not all large numerical aperture devices are Lambertian. The light emitters 103 may be a light source, such as a surface-emitting LED, an organic LED (OLED), an edge emitting light emitting diode, a laser diode, a diode-pumped solid state (DPSS) laser, a fiber optic light source, or another suitable light source. Such sources may emit light in a cone or Lambertian pattern that fills the curved mirror 108 substantially uniformly. Although the efficiency of the light emitters 103 may be less than optimum because a portion of the light emitted from the light emitters 103 may miss the curved mirror 108, the numerical aperture of the light emitters 103 may be substantially matched to the collection numerical aperture of the curved mirror 108 to provide greater efficiency, while meeting other design constraints. Uniformly filling the curved mirror 108 improves image uniformity because different portions of the beams 118a-118c projected by the curved mirror 108 enter the pupil 112 from different angles during a horizontal and vertical sweep of the beams 118a-118c. Thus, pixels near the top of the displayed image use one portion of the beams 118a-118c, pixels near the middle of the image use another portion of the beams 118a-118c, and pixels near the bottom use yet another portion of the beams 118a-118c. The different portions of the beams 118a-118c that are used to form an image is a continuum with the portion of the beams 118a-118c entering the pupil 112 constantly changing as the collimated beams 118a-118c are scanned back and forth.

In some embodiments, each of the light emitters 103 may be a triad of red/green/blue (“RGB”) emitters or a quadrad of red/green/blue/green (“RGBG”) emitters. Also, while the embodiments have been described as having a linear array of light emitters 103, individual light emitters 103 may, in fact, be offset to allow for manufacturability or other issues. Rather, it may be appropriate for individual light emitters 103 to be placed in pattern such as, for example, a series of diagonal lines arranged on a linear major axis. If the light emitters 103 are offset by a substantial portion of a pixel pitch or greater, pixel timing may be modified to account for the positional variation of the light emitters 103 relative to the scan angle of the curved mirror 108. Finally, although the linear arrays 102a-102c have been referred to as linear, in some embodiments, the linear arrays 102a-102c may be curved to correspond to the curvature of the curved mirror 108 so that the distance between the curved mirror 108 and each of the light emitters 103 thereon is constant and the light emitters 103 remain a fixed distance from the curved mirror 108.

Again referring to FIG. 1, in operation, the beams 118a-118c may be scanned across the viewer's pupil 112 in the vertical z-axis direction by tilting, i.e., rotating the curved mirror 108 about the x-axis, vertically moving the curved mirror 108 in the z-axis direction without rotating the curved mirror 108, or combinations thereof. Similarly, the beams 118a-118c may be scanned in the horizontal x-axis direction by tilting, i.e., rotating the curved mirror 108 about the z-axis, horizontally moving the curved mirror 108 in the x-axis direction without rotating the curved mirror 108, or combinations thereof. If the curved mirror 108 is scanned, the amount of movement of the curved mirror 108 accounts for the vertical position of the particular linear array of light emitters 102a-102c that is emitting light in order to form a pixel line having pixels provided from one of the linear array of light emitters 102a-102c and pixels provided from another one of the linear array of light emitters 102a-102c. In one embodiment, each of the linear array of light emitters 102a-102c is fully populated with one light emitter 103 for each pixel of a horizontal image line. In such an embodiment, the beams 118a-118c only need to be scanned in the vertical direction to provide all of the pixels that define the image. In another embodiment, the curved mirror 108 is held substantially stationary and the light source 102 is moved vertically and, if necessary horizontally, to scan the beams 118a-118c. In this embodiment, light emitters 103 of one of the linear array of light emitters 102a-102c emit light that is associated with pixels of a given horizontal pixel line and the light source 102 is moved so that another one of the linear array of light emitters 102a-102c is positioned relative to the curved mirror 108 so that light emitted from light emitters 103 thereon will provide pixels for the same horizontal pixel line, but such pixels will have a different apparent depth. Each image frame displayed to the viewer is generated by the scanning of the beams 118a-118c in conjunction with modulation of the intensity of the light emitters 103 and electronically selecting which particular linear array 102a-102c is used to provide the light to vary the apparent depth of selected pixels of the image frame.

According to one embodiment, the curved mirror 108 is scanned at a frame rate of, 60 Hz for example, and the intensity of each light emitter 103 is modulated at a frequency of 36 KHz to provide a display having the quality of an SVGA display. In this embodiment, each of the arrays 102a-102c may include 800 respective red, green, and blue light emitters 103 (2400 total light emitters 103). In alternative embodiments, the scanning frequency of the curved mirror 108 may be increased, for example to 600 Hz, and the number of light emitters 103 in each of the arrays 102a-102c may be reduced. According to another embodiment, the light source 102 is scanned at a frame rate of, for example, 60 Hz and the intensity of each light emitter 103 is modulated at a frequency of 36 KHz to provide a display having the quality of an SVGA display. Other combinations may also be used.

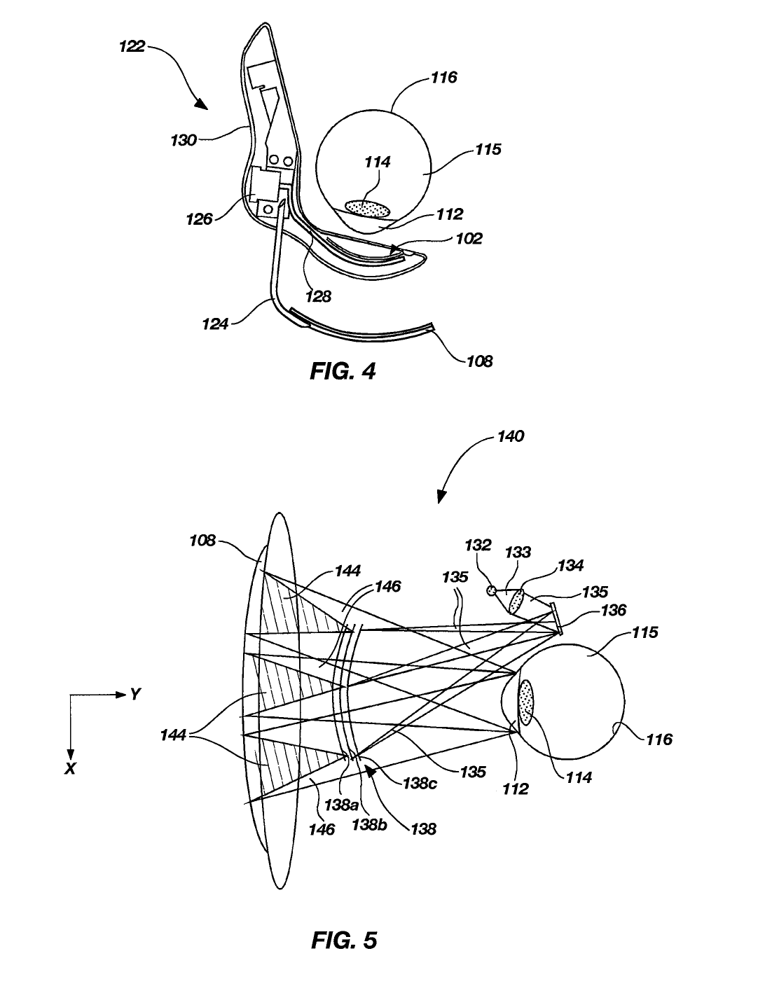

FIGS. 3 and 4 show an embodiment for a head-mounted see-through display 122. In the display 122, the curved mirror 108 is connected to supports 124 that hold the curved mirror 108 substantially stationary in front of the viewer's eye 115. The display 122 further includes a support arm 128 that carries the light source 102. The light source 102 includes fully populated linear arrays 102a-102c of light emitters 130 so that the light emitted therefrom only needs to be scanned in the vertical z-axis direction. The display 122 further includes an actuator mechanism 126 enclosed in a housing 103 that is operable to rotate the support arm 128 that carries the light source 102. The actuator mechanism 126 is operably coupled to the support arm 128 and is configured to rotate the light source 102 so that the distance of each of the light emitters 103 from the curved mirror 108 remains constant as it is moved vertically. The light emitted from the light source 102 is scanned in a manner similar to the display 100 of FIG. 1 by rotating the light source 102 using the support arm 128, while the curved mirror 108 is held substantially stationary in front of the eye of the viewer.

FIG. 5 shows a top view of a scanned light display 140 in which the light source is formed from a photoluminescent material and is optically addressable to emit light instead of the light source being electrically addressable as in the display 100 of FIG. 1. The display 140 includes a modulatable excitation light source 132, such as a ultraviolet (UV) diode, operable to emit violet and/or UV light 133. While the wavelength of the excitation light source 132 is referred to as UV herein, it will be understood that such reference also refers to other excitation wavelengths. Particularly, diodes commonly referred to as UV diodes may emit in the violet region of the visible spectrum, such as about 405 to 415 nanometers in wavelength.

The display 140 may further include a focusing element 134, such as a lens, configured to focus the light 133 emitted from the excitation light source 132 into a collimated beam 135. A biaxial MEMS-type scanner 136 is configured to scan the collimated beam 135, and may be configured to further focus the beam 135, onto selected locations of a light source 138 that includes a plurality of linear photoluminescent arrays 138a-138c. As with the display 100 of FIG. 1, each of the linear arrays 138 are positioned at a fixed distance from the curved mirror 108. In another embodiment, the focusing element 134 may be omitted if the scanner 136 employs a curved mirror 108 for directly collimating the light 133 emitted from the excitation light source 132. Thus, the scanner 136 is operable to optically address selected photoluminescent materials in the plurality of linear photoluminescent arrays 138a-138c. The plurality of linear photoluminescent arrays 138a-138c provides the same function as the light source 102 in the display 100 of FIG. 1, except instead of having a plurality of light emitters 103, such as LEDs, each of the linear photoluminescent arrays 138a-138c has a plurality of discrete portions of photoluminescent material that emits light in response to absorption of light at a selected wavelength or over a selected range of wavelengths. The light emitted from the plurality of linear photoluminescent arrays 138 is reflected from the curved mirror 108.

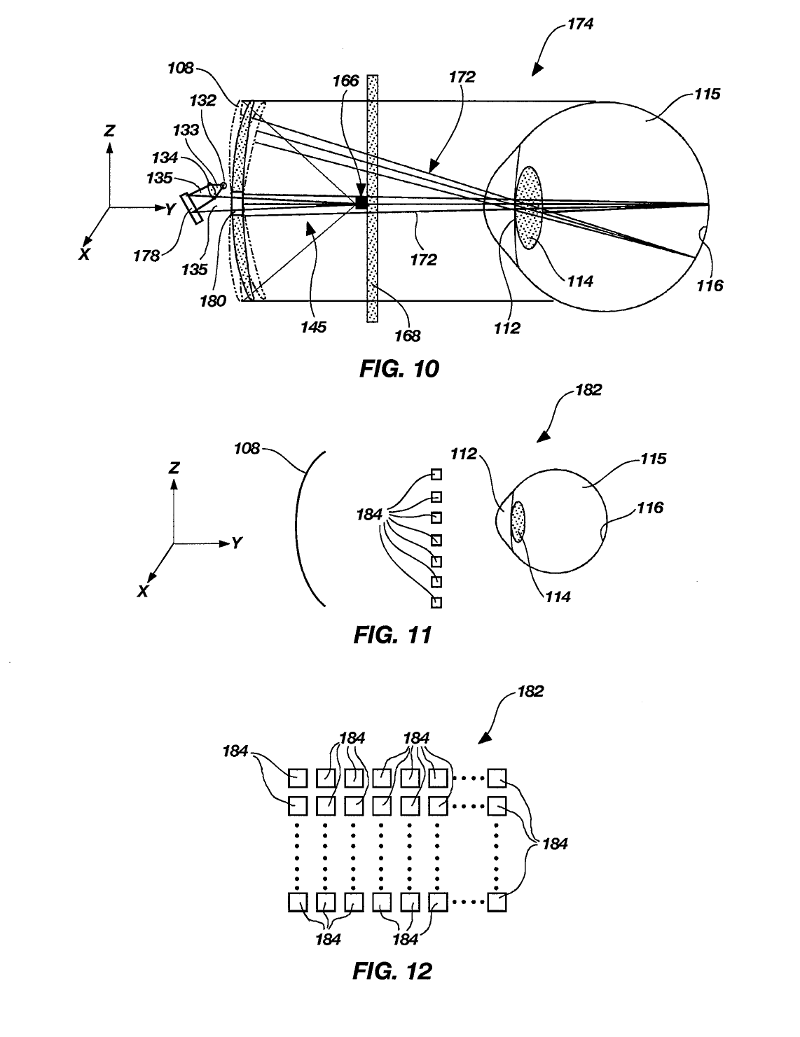

In the display 140, the scanner 136 scans the light 135 onto the back of the plurality of linear photoluminescent arrays 138a-138c. However, in another embodiment, the scanner 136 may scan the light 133 from the excitation light source 132 onto a UV mirror positioned between the light source 138 and the curved mirror 108 that reflects the light 135 onto the front of the plurality of linear photoluminescent arrays 138a-138c to excite selected portions thereof or the curved mirror 108 may be at least partially transmissive to the UV light from the excitation source 132 so that the scanner 136 may scan the light 135 through the curved mirror 108 to excite selected discrete portions of photoluminescent material of the plurality of linear photoluminescent arrays 138a-138c. In another embodiment, the curved mirror 108 has an aperture that allows the light 135 from the scanner 136 to pass therethrough. Such embodiments in which the light is scanned onto a UV mirror or through the curved mirror 108 are more clearly shown and described with respect to the display embodiments of FIGS. 9 and 10. While not shown explicitly in FIG. 5, it may be advantageous in embodiments using violet or UV light to include a filter to substantially reduce or eliminate the transmission of such light to the viewer's eye.

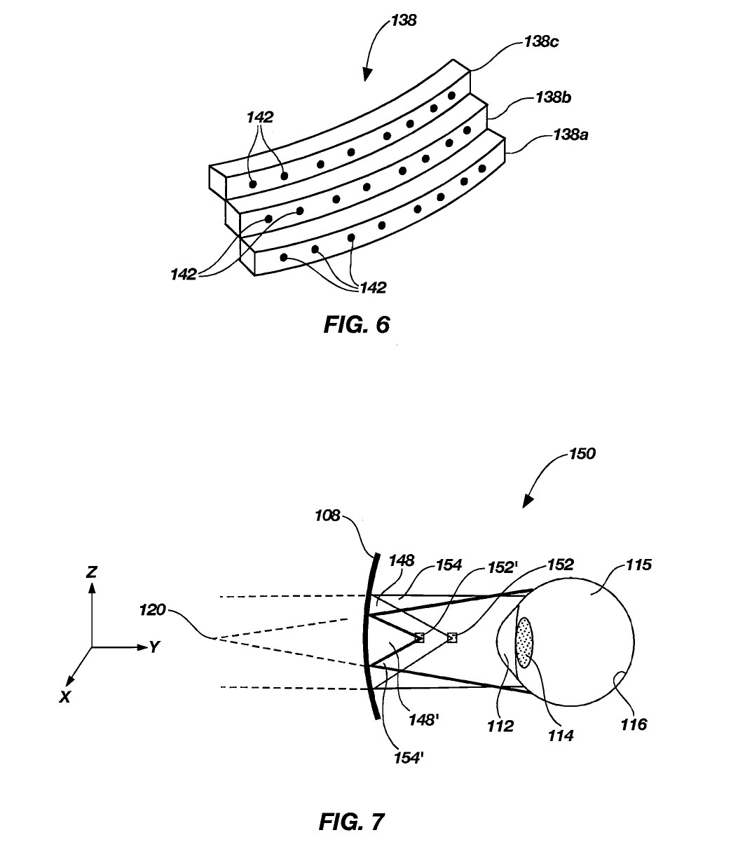

As shown in FIG. 6, each of the linear photoluminescent arrays 138a-138c includes a plurality of discrete portions of photoluminecent material 142 spaced apart along the length thereof. In the configuration of the light source 138, each of the discrete portions of photoluminescent material 142 in respective linear photoluminescent arrays 138a-138c is offset from each other a fixed distance. As with the linear arrays 102a-102c of FIG. 1, the linear photoluminescent arrays 138a-138c may be curved to correspond to the curvature of the curved mirror 108, and in some embodiments may be fully populated arrays so that each of the linear photoluminescent arrays 138a-138c has one of the photoluminescent materials 142 for each pixel of a horizontal image line. The photoluminescent materials 142 may be up-converting or down-converting materials, and examples of materials suitable for the photoluminescent material 142 include, but are not limited to, zinc sulfide doped with copper (ZnS:Cu), zinc sulfide doped with aluminum (ZnS:Al), coumarin, fluorescein, rhodamine, neodymium doped yttrium aluminum garnet (Nd:YAG), Y₃Al₅O₂:Nd, yttrium oxysulfide doped with europium (Y₂O₂S:Eu), a nanoparticle (e.g., a quantum dot), and a fluorescing ion in a medium such as glass. Additional materials and structures suitable for the photoluminescent material 142 includes, but is not limited to, a fluorescent material such as perylene dissolved in a solvent of cyclohexane which is incorporated into a capsule, laser dye Pyrromethene 597 which may be dissolved in ethanol, and a dye polymer such as IR 125. The photoluminescent material 142 may also be of a type described in, for example; Shigeo Shionoya and William M. Yen, eds, PHOSPHOR HANDBOOK, CRC Press (1999); Wise, Donald L. et al., eds, PHOTONIC POLYMER SYSTEMS, Marcel Dekker (1998); and/or Berlman, Isadore B., HANDBOOK OF FLUORESCENCE SPECTRA OF AROMATIC MOLECULES, Academic Press (1965); all hereby incorporated by reference. In one embodiment, the photoluminescent material 142 includes different photoluminescent materials arranged spatially proximate to each other that emit light at red, green, and blue wavelengths respectively in response to excitation light at the same wavelength to form an RGB triad or an RGBG quadrad.

One advantage of the light source 138 shown in FIG. 6 compared with the light source 102 shown in FIG. 2 is that the light source 138 is typically a lower mass structure because it employs photoluminescent materials instead of heavier light emitters such as LEDs. Accordingly, the relatively lower mass of the light source 138 facilitates scanning it at a relatively faster rate and simplification of the actuator that moves the light source 138.

Again referring to FIG. 5, in operation, the excitation light source 132 emits the light 133, which is optionally collimated into the beam 135 by the focusing element 134 or collimated directly by the biaxial scanner 136. The biaxial scanner 136 scans the beam 135 to optically address a selected photoluminescent material 142 of the linear photoluminescent arrays 138a-138c depending upon the desired apparent depth of the pixel to be generated. For example, the light emitted from the linear photoluminescent array 138a may provide a pixel or pixels that appear closer to the viewer, while pixel or pixels provided by the light emitted from the linear photoluminescent array 138b and 138c will appear relatively farther away to the viewer due to the linear photoluminescent array 138b and 138c being positioned further away from the curved mirror 108. The selected photoluminescent material 142 emits light 144, which is reflected by the curved mirror 108 to form beam 146. The beams 146 may be scanned across the viewer's pupil 112 and, ultimately focused by the viewer's lens onto the retina 116 to form the 3D image frame, in the same manner employed in the display 100 of FIG. 1, and in the interest of brevity will not be discussed in detail.

According to one embodiment, the curved mirror 108 is scanned at a frame rate of 60 Hz, for example, and the intensity of the excitation light source 132 is modulated at a frequency of 36 KHz to provide a display having the quality of an SVGA display.

According to another embodiment, the light source 138 is scanned at a frame rate of 60 Hz, for example, and the intensity of the excitation light source 132 is modulated at a frequency of 36 KHz to provide a display having the quality of an SVGA display. Other combinations may also be used.

FIG. 7 shows another embodiment of a scanned light display 150 in which the apparent depth of the light scanned across the viewer's pupil 112 is altered by relatively moving the position of a light source 152 generally in the direction of a principal axis of the curved mirror 108, such as a radius of the curved mirror 108. In the display 150, the light source 152 may be selected from any of the aforementioned light sources used for the light emitters 103, and may be configured as a single light emitter or, for example, as a linear or two dimensional array of light emitters. The light source 152 is operable to emit diverging light 154, and the apparent image depth of the pixels generated by such light may be controlled by moving the light source 152 to alter the distance between the curved mirror 108 and the light source 152. FIG. 7 shows two positions for the light source represented by the light source 152 positioned on or proximate the focal surface of the curved mirror 108 and light source 152′ moved to a position off of the focal surface of the curved mirror 108. As with the display 100 of FIG. 1, partially collimated, divergent beam 148′ reflected from the curved mirror 108 corresponds to the apparent depth 120 that will appear relatively closer to the viewer than the fully collimated beam 148 corresponding to when the light source 152 is positioned on or proximate the focal surface of the curved mirror 108. In the display 150, the light source 152 may be moved to alter the distance between the curved mirror 108 and the light source 152 using a first actuator and a second actuator may be used to scan the beams 148 and 148′ by relatively moving the curved mirror 108 and the light source 152 in a manner similar to the display 100. For example, the second actuator may scan the curved mirror 108 or the light source 152. In one embodiment, the first and second actuators form a single actuator.

In operation, the light source 152 emits diverging light 148 that is scanned across the viewer's pupil 112 by scanning the curved mirror 108 or the light source 152 in a manner similar to the display 100 of FIG. 1. Each image frame is formed by the modulation of the intensity of the light source 152 in conjunction with selectively varying the apparent depth of selected pixels by moving the light source 152 to alter the distance between the light source 152 and the curved mirror 108, and scanning of the beams 154 reflected from the curved mirror 108. According to one embodiment, the curved mirror 108 is scanned at a frame rate of 60 Hz, for example, and the intensity and, if appropriate, the position of each light emitter of the light source 152 is modulated at a frequency of 36 KHz to provide a display having the quality of an SVGA display. In alternative embodiments, the scanning frequency of the curved mirror 108 may be increased, for example, to 600 Hz, and the number of light emitters of the light source 152 may be reduced. According to another embodiment, the light source 152 is scanned at a frame rate of 60 Hz, for example, and the intensity and, if appropriate, the position of each light emitter thereof is modulated at a frequency of 36 KHz to provide a display having the quality of an SVGA display. Other combinations may also be used.

In yet another embodiment, the light source 152 may be a photoluminescent light source such as, for example, a linear array of discrete portions of photoluminescent material 142 formed from any of the aforementioned photoluminescent materials. In such an embodiment, an excitation light source may be used to effect emission of light from the photoluminescent material 142 in a manner similar to that employed in the scanned light display 140 of FIG. 5.

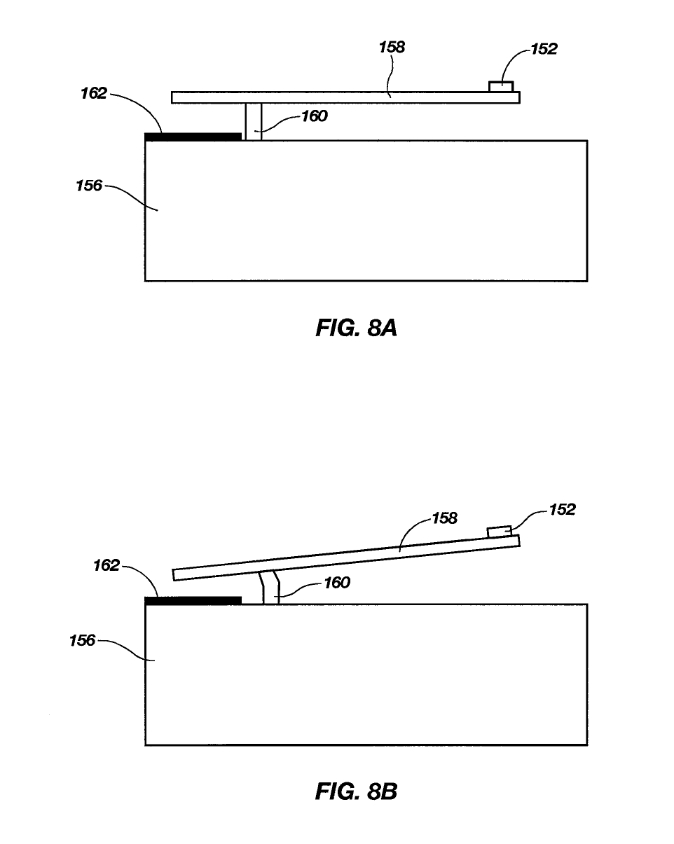

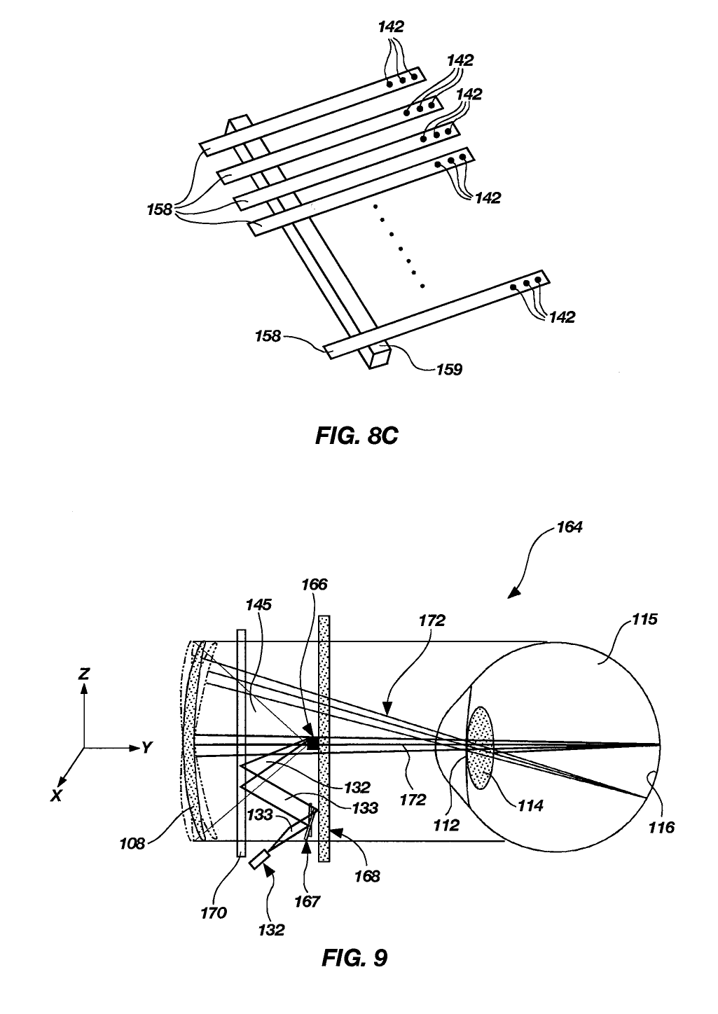

One embodiment of an electrostatic actuator suitable for moving the light source 152 toward or away from the curved mirror 108 is shown in FIGS. 8A and 8B. The electrostatic actuator includes a cantilever beam 158 formed of a conductive material, such as polysilicon or an insulating material that is plated over with a metal or alloy. The cantilever beam 158 has the light source 152 mounted near an end thereof. The cantilever beam 158 is supported over a substrate 156, formed of a material such as a partial silicon wafer, by a column 160 that provides a suitable amount of standoff between the bottom of the cantilever beam 158 and the top surface of the substrate 156. The standoff between the bottom of the cantilever beam 158 and the top surface of the substrate 156 enables the cantilever beam 158 to deflect a sufficient amount. An electrical contact 162 is formed on the substrate 156 from a metal or alloy. As shown in FIG. 8B, the position of the light source 152 may be altered by applying a voltage between the electrical contact 162 and the cantilever beam 158 to bias the end of the cantilever beam 158 proximate the electrical contact 162 toward the substrate 156 and the end of the cantilever beam 158 distal from the electrical contact 162 that supports the light source 152 consequently away from the substrate 156. According to another embodiment, the cantilever beam 158 is fabricated from two materials having different thermal-physical properties (e.g., thermal conductivity and/or thermal expansion), and the deflection thereof is controlled by passing an airflow to alter the temperature of the cantilever beam 158 causing it to bend. In yet another embodiment, the cantilever beams 158 are deflected using one or more electromagnetic actuators. According to some embodiments, the apparent lateral movement of the light source 152 encountered during axial movement is slight relative to pixel size and addressability, and may be ignored. According to other embodiments, light source 152 timing may be adjusted to accommodate such lateral displacement and/or other artifacts corresponding to the physical embodiment of the actuator.

In one embodiment shown in FIG. 8C, a plurality of cantilever beams 158 such as, for example, 800 cantilever beams are provided. Each of the cantilever beams 158 may have three or four discrete portions of photoluminescent material 142 on an end thereof having the characteristics for providing an RGB or RGBG emitter.

FIG. 9 shows a scanned light display 164 that employs an optically addressable linear photoluminescent array 166 according to one embodiment. In the display 164, the position of the linear photoluminescent array 166 may be altered using an actuator, such as the electrostatic actuator shown in FIGS. 8A and 8B. Although the linear photoluminescent array 166 is referred to as linear, in some embodiments, the linear photoluminescent array 166 may be curved to correspond to the curvature of the curved mirror 108 so that the distance between the curved mirror 108 and each of the discrete portions of photoluminescent material 142 thereon is constant and the discrete portions of photoluminescent material 142 remain a fixed distance from the curved mirror 108. The display 164 includes the curved mirror 108 and the linear photoluminescent array 166 positioned in front of the viewer's eye 115. The display 164 further includes an excitation light source 132 operable to emit UV light and a MEMS-type scanner 167 operable to collimate the UV light into a collimated beam and scan the collimated beam onto a UV mirror 170. By scanning the light emitted from the excitation light source 132 off of the UV mirror 170 the location on the linear photoluminescent array 166 that absorbs light may be accurately controlled. A UV filter 168 is positioned between the linear photoluminescent array 166 and the viewer's eye 115 to filter harmful UV light from reaching the viewer's eye 115 and light reflected off of the viewer's face.

In operation, the excitation light source 132 emits diverging UV light that is scanned onto selected locations of the UV mirror 170, and is reflected thereby onto selected locations of the linear photoluminescent array 166. The discrete portions of photoluminescent material 142 of the linear photoluminescent array 166 emits the light 145 at a secondary wavelength in response to excitation by the light 133. The light 145 is reflected by the curved mirror 108 as a beam 172 and vertically scanned by rotating the curved mirror 108 (shown in FIG. 9 in three different scan positions), vertically moving the curved mirror 108, or combinations thereof. If the linear photoluminescent array 166 is fully populated with one or more discrete photoluminescent materials per pixel of a horizontal image line, the beams 172 only need to be scanned vertically. If the linear photoluminescent array 166 is not fully populated, the beams 172 may need to be scanned in both the horizontal and vertical directions to provide all of the pixels that define the image. Each image frame is formed by modulation of the intensity of the excitation light source 132 in conjunction with selectively varying the apparent depth of selected pixels by moving the linear photoluminescent array 166 to alter the distance between the linear photoluminescent array 166 and the curved mirror 108, and scanning of the beams 172 reflected from the curved mirror 108.

One advantage of the linear photoluminescent array 166 shown in FIG. 9 compared with the light source 102 shown in FIG. 2 or a linear array of light emitters is that the linear photoluminescent array 166 is typically a lower mass structure because it employs photoluminescent materials instead of heavier light emitters such as LEDs. Accordingly, the relatively lower mass of the linear photoluminescent array 166 facilitates moving it at a sufficient rate toward and away from the curved mirror 108 to control the apparent depth of selected pixels.

FIG. 10 shows another scanned light display 174 that also uses an optically addressable linear photoluminescent array 166 according to one embodiment. The display 174 has many of the same components that are included in the display 164 of FIG. 9. Therefore, in the interest of brevity, the components of the two displays 164, 174 that correspond to each other have been provided with the same reference numerals, and an explanation of their structure and operation will not be repeated. Instead of using the UV mirror 170, a MEMS-type scanner 178 is employed that is operable to scan light 133 emitted by the excitation light source 132. In one embodiment, the light 133 is collimated into a beam 135 using the focusing element 134, while in other embodiments the mirror of the scanner 178 may be curved to directly collimate the light 133 into the beam 135, eliminating the need for the focusing element 134. In one embodiment shown in FIG. 10, the beam 135 is transmitted through an aperture 180 in the curved mirror 108. In another embodiment, the curved mirror 108 is at least partially transmissive to UV light to enable the beam 135 to pass directly through the curved mirror 108 without the need for the aperture 180. In both embodiments, the beam 180 is scanned onto selected locations of the linear photoluminescent array 166 to cause the discrete portions of photoluminescent material thereof to emit light 145 at one or more secondary wavelengths. The light 145 is then reflected by the curved mirror 108 into a beam 172, and scanned in a manner similar to the display 164 of FIG. 9. The image frame is formed by modulation of the intensity of the excitation light source 132 in conjunction with selectively varying the apparent depth of selected pixels by moving the linear photoluminescent array 166 to alter the distance between the linear photoluminescent array 166 and the curved mirror 108, and scanning of the beams 172 reflected from the curved mirror 108.

According to one embodiment applicable to both the displays 164 and 174 of FIGS. 9 and 10, the curved mirror 108 is scanned at a frame rate of 60 Hz, for example, and the intensity and, if appropriate, the position of the linear photoluminescent array 166 is modulated at a frequency of 36 KHz to provide a display having the quality of an SVGA display.

FIGS. 11 and 12 show one embodiment for a non-scanned display 182 that includes a two-dimensional (2D) array of light sources 184 that is fully populated in both the horizontal and vertical directions so that there is one pixel for each of the light sources 184. Thus, unlike the aforementioned scanned light displays of FIGS. 1-7, 9, and 10, the light emitted from the light sources 184 does not have to be scanned in order to generate an image. Each of the light sources 184 may be any of the aforementioned light sources such as a surface-emitting LED light source, an OLED light source, a photoluminescent material, or another suitable light source. If the light source 184 includes one or more discrete portions of photoluminescent material 142, the display 182 includes an excitation light source that is used to optically address the particular light source 184 that corresponds to a particular pixel. In one embodiment, actuators such as those described in FIGS. 8A through 8C employing the cantilever beams 158 carry each of the light sources 184, and are operable to selectively vary the position of the light source 184 relative to the curved mirror 108 in the y-axis direction. In operation, the intensity of each of the light sources 184 is modulated and light emitted therefrom is reflected from the curved mirror 108. Each image frame displayed to the viewer is generated by the modulation of the light sources 184 in conjunction with varying the position of selected light sources 184 in order to vary the apparent depth of pixels that are provided from such light sources.

While the embodiments shown and described with respect to the displays of FIGS. 1-7 and 9-12 use light emitters such as LEDs or photoluminescent materials as pixel sources, many other types of pixel sources for providing light may be used. In additional embodiments, instead of using the light emitters or photoluminescent materials, 1-D or 2-D LCD panels may be used as the pixel sources.

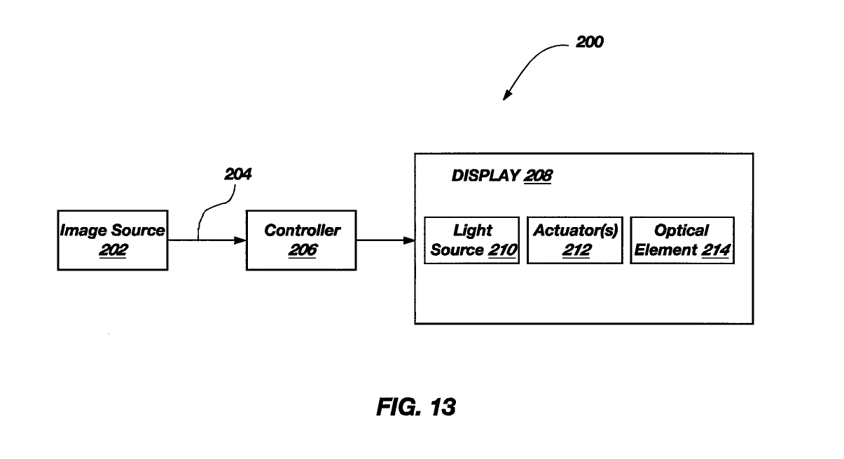

FIG. 13 shows a simplified block diagram of a display system 200 employing any of the aforementioned displays according to one embodiment. The display system 200 includes an image source 202 operable to produce an image signal 204. The image signal 204 may be a VGA signal, SVGA signal, or another suitable image signal format. The image signal 204 may include information associated with the intensity, color, and apparent depth of the pixels to be generated by the display system 200. The display system 200 further includes a controller 206 operably coupled to the image source 202 and to a display 208 having a light source 210, one or more actuators 212, and an optical element 214 (e.g., a curved mirror). The display 208 may be any of the aforementioned scanning or non-scanning light displays. The controller 206 receives the image signal 204 and controls the modulation of the light source 206 and the operation of the actuator(s) 212 to effect image generation. For example, in the display 100, the controller 206 drives a single actuator 212 to move the light source 210 in order to scan light emitted therefrom, and to electrically address and position light emitters in a proper position to vary the apparent depth of selected pixels of a pixel line. In the display 150 of FIG. 7, the controller 206 drives a first actuator 212 to move the light source 210 and the optical element 214 relative to each other in a first direction to effect scanning of light emitted from the light source 210 and drives a second actuator to move the light source 210 in a second direction toward and away from the curved mirror 108 to vary the apparent depth of selected pixels. The operation and function of the controller 206 in conjunction with the light source 210 and actuator(s) 212 will be apparent from review of the description of the embodiments for the other displays previously described.

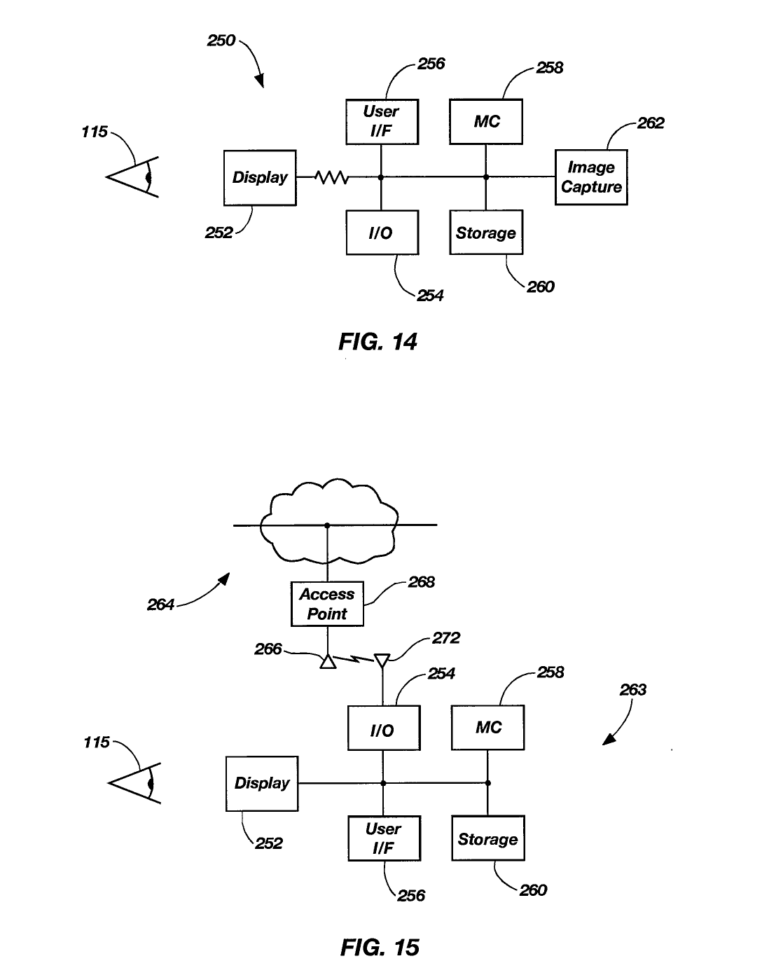

FIG. 14 shows a block diagram of a system 250, such as a camera, that uses a scanned light display 252 configured as one of the aforementioned scanned beam displays or systems to provide images to the eye of a viewer 115 according to one embodiment. An optional digital image capture subsystem 262 is controlled by a microcontroller 258 to continuously or selectively capture still or video images according to user control received via user interface 256. According to the wishes of the user, images or video may be stored in local storage 260 and/or alternatively may be sent to an external system through input/output interface 254. The system 250 may be controlled to display a live image that is received by the image capture system 262 or alternatively may be controlled to display stored images or video retrieved from the storage 260.

FIG. 15 shows a block diagram of a media viewing system 263 that uses the scanned light display 252 configured as one of the aforementioned scanned beam displays or systems to provide images to the eye of a viewer 115 according to one embodiment. The media viewing system 263 receives images from media delivery infrastructure 264, which may for example include video or still image delivery services over the Internet, a cellular telephone network, a satellite system, terrestrial broadcast or cable television, a plug-in card, a CD or DVD, or other media sources known in the art. For example, the media delivery infrastructure 264 may include a video gaming system for providing a video gaming image, a digital camera, or a recorded media player. In the embodiment of FIG. 15, an access point 268 provides a signal via wireless or non-wireless interface 266 to an input/output of the media viewer 263 via a wireless interface 272 interfaced to the remainder of the media viewer 263 via communication interface 254. As used herein, the term communication interface may be used to collectively refer to the wireless interface 272 (e.g., an antenna as shown) and the radio and/or other interface to which it is connected. Media may be delivered across the communication interface in real time for viewing on the display 252, or may alternatively be buffered by the microcontroller 258 in local storage 260. User controls comprising a user interface 256 may be used to control the receipt and viewing of media. The media viewing system 263 may for example be configured as a pocket media viewer, a cellular telephone, a portable Internet access device, or other wired or wireless device.

Although the invention has been described with reference to the disclosed embodiments, persons skilled in the art will recognize that changes may be made in form and detail without departing from the spirit and scope of the invention. For example, the concepts of varying the apparent depth of selected pixels in an image by altering the distance between the pixel source and an optical element may be used in LCD technology or other similar display technology. Additionally, the optical elements, such as a curved mirror, and the pixel sources employed in the disclosed embodiments do not need to be positioned in front of the eye of the viewer. Instead, beam splitters or other optical components may be used to redirect the light provided by the optical element onto the eye of the viewer. Such modifications are well within the skill of those ordinarily skilled in the art. Accordingly, the invention is not limited except as by the appended claims.

What is claimed is:

1. A scanned light display system for providing an image, comprising:
a collimating element configured to at least partially collimate light;
a first and at least a second set of pixel sources operable to project light toward the collimating element, the first set of pixel sources offset a fixed distance from the at least a second set of pixel sources so that light provided by the pixel sources of the first set of pixel sources and light provided by the pixel sources of the at least a second set of pixel sources is at least partially collimated by the collimating element to different extents to provide pixels having different apparent depths in the image; and
an actuator operable to move the collimating element and the first and at least a second set of pixel sources relative to each other in order to scan the at least partially collimated light to form the image.

2. The scanned light display system of claim 1 wherein at least one of the pixel sources is operable to be electrically addressed.

3. The scanned light display system of claim 1 wherein each of the pixel sources comprises at least one light emitter.

4. The scanned light display system of claim 1 wherein at least one of the pixel sources is operable to be optically addressed.

5. The scanned light display system of claim 1 wherein each of the pixel sources comprises at least one portion of photoluminescent material.

6. The scanned light display system of claim 5 wherein the at least one portion of photoluminescent material comprises one of an up-converting photoluminescent material and a down converting photoluminescent material.

7. The scanned light display system of claim 5 wherein the at least one portion of photoluminescent material comprises at least one of coumarin, fluorescein, rhodamine, neodimium doped yttrium aluminum Garnet (Nd:YAG), Y₃Al₅O₁₂:Nd, zinc sulfide doped with copper (ZnS:Cu), zinc sulfide doped with aluminum (ZnS:Al), yttrium oxysulfide doped with europium (Y₂O₂S:Eu), a solvated fluorescent material, photoluminescent particles dispersed in a polymer matrix, a fluorescing ion in a glass medium, a short chain organic dye in a polymer medium, and a long chain organic dye.

8. The scanned light display system of claim 5, further comprising an excitation light source and a scanner operable to scan light emitted from the excitation light source in order to selectively irradiate the at least one portion of photoluminescent material of the first and at least a second set of pixel sources.

9. The scanned light display system of claim 8 wherein the excitation light source comprises at least one of a violet light source and an ultraviolet light source.

10. The scanned light display system of claim 1 wherein the collimating element comprises a curved mirror.

11. The scanned light display system of claim 10 wherein the curved mirror comprises a spherical mirror.

12. The scanned light display system of claim 10 wherein the curved mirror comprises a Fresnel mirror.

13. The scanned light display system of claim 10 wherein the curved mirror comprises a diffractive mirror.

14. The scanned light display system of claim 1 wherein the collimating element is maintained substantially stationary and the actuator is operable to move the first and at least a second set of pixel sources.

15. The scanned light display system of claim 1 wherein the first and at least a second set of pixel sources are maintained substantially stationary and the actuator is operable to move the collimating element.

16. The scanned light display system of claim 1 wherein the collimating element comprises a curved mirror and wherein the actuator is operable to move the first and at least a second set of pixel sources in a manner that maintains the distance between the first and at least a second set of pixel sources and the curved mirror substantially constant as the actuator moves the first and at least a second set of pixel sources.

17. The scanned light display system of claim 1 wherein each of the first and at least a second set of pixel sources comprises a substantially linear array of light emitters.

18. The scanned light display system of claim 1 wherein each of the first and at least a second set of pixel sources comprises a substantially linear array of portions of photoluminescent material.

19. The scanned light display system of claim 1 wherein the collimating element comprises a curved mirror that is at least partially transparent.

20. The scanned light display system of claim 1 wherein the image is an image frame and wherein the first and at least a second set of pixel sources provides pixels having different respective apparent depths in the image frame.

21. The scanned light display system of claim 1, further comprising a controller coupled to the pixel sources and the actuator, the controller being operable to couple signals to the pixel sources and the actuator.

22. The scanned light display system of claim 21, further comprising an image capture system.

23. The scanned light display system of claim 21, further comprising an image generation system and wherein the controller is operable to scan the light provided by the pixel sources to provide the image responsive to a signal from the image generation system.

24. The scanned light display system of claim 23 wherein the image generation system comprises one of a video gaming system, a digital camera, a recorded media player, and a television receiver.

25. The scanned light display system of claim 1 wherein each of the pixel sources comprises one of a surface-emitting light emitting diode (LED), an organic LED, an edge emitting LED, a laser diode, a liquid crystal display panel, a diode-pumped solid state laser, a photoluminescent material, a reflector, and a fiber-optic source.

26. A method of varying the apparent depth of pixels in an image, the method comprising:
providing light from a first set of pixel sources;
at least partially collimating the light provided from the first set of pixel sources with an optical element to provide first pixels having a first apparent depth;
providing light from a second set of pixel sources offset from the first set of pixel sources by a distance; and
at least partially collimating the light provided from the second set of pixel sources with the optical element to provide second pixels having a second apparent depth different from the first apparent depth.

27. The method of claim 26 wherein the act of providing light from a first set of pixel sources comprises emitting light from a first set of light emitters and wherein the act of providing light from a second set of pixel sources comprises emitting light from a second set of light emitters.

28. The method of claim 26 wherein the act of providing light from a first set of pixel sources comprises emitting light from a first set of portions of photoluminescent material and wherein the act of providing light from a second set of pixel sources comprises emitting light from a second set of portions of photoluminescent material.

29. The method of claim 26, further comprising relatively moving the second set of pixel sources and the optical element so that second pixels are provided on the same image line as the first pixels.

30. The method of claim 26 wherein the first pixels and second pixels are provided in the same image frame.

31. The method of claim 26 wherein the optical element comprises a curved mirror.

32. The method of claim 31 wherein the curved mirror comprises a spherical mirror.

33. The method of claim 31 wherein the curved mirror comprises a Fresnel mirror.

34. The method of claim 31 wherein the curved mirror comprises a diffractive mirror.

35. The method of claim 26 wherein the acts of providing light from a first set of pixel sources comprises selectively addressing at least one pixel source of the first set of pixel sources and wherein the act of providing light from a second set of pixel sources comprises selectively addressing at least one pixel source of the second set of pixel sources.

36. A scanned light display system for providing an image, comprising:
a pixel source operable to provide diverging light;
a curved mirror positioned to receive at least a portion of the light and configured to at least partially collimate the received light;
a first actuator operable to relatively move the pixel source and the curved mirror in at least one of a direction toward each other and a direction away from each other so that light provided by the pixel source is at least partially collimated by the curved mirror to different extents depending upon the location of the pixel source to provide pixels having different apparent depths in the image; and
a second actuator operable to relatively move the curved mirror and the pixel source to scan the received light to form the image.

37. The scanned light display system of claim 36 wherein the first and second actuators comprise a single actuator.

38. The scanned light display system of claim 36 wherein the pixel source is operable to be electrically addressed.

39. The scanned light display system of claim 36 wherein the pixel source comprises a plurality of light emitters.

40. The scanned light display system of claim 36 wherein the pixel source is operable to be optically addressed.

41. The scanned light display system of claim 36 wherein the pixel source comprises a plurality of portions of photoluminescent material.

42. The scanned light display system of claim 41 wherein each of the portions of photoluminescent material comprises one of an up-converting photoluminescent material and a down converting photoluminescent material.

43. The scanned light display system of claim 41 wherein each of the portions of photoluminescent material comprises at least one of coumarin, fluorescein, rhodamine, neodimium doped yttrium aluminum Garnet (Nd:YAG), Y₃Al₅O₁₂:Nd, zinc sulfide doped with copper (ZnS:Cu), zinc sulfide doped with aluminum (ZnS:Al), yttrium oxysulfide doped with europium (Y₂O₂S:Eu), a solvated fluorescent material, photoluminescent particles dispersed in a polymer matrix, a fluorescing ion in a glass medium, a short chain organic dye in a polymer medium, and a long chain organic dye.

44. The scanned light display system of claim 41, further comprising an excitation light source and a scanner operable to scan light emitted from the excitation light source in order to selectively irradiate the portions of photoluminescent material of the pixel source.

45. The scanned light display system of claim 36 wherein the curved mirror is configured to transmit light emitted from the excitation source; and wherein the excitation light source is positioned so that light emitted therefrom is transmitted through the curved mirror.

46. The scanned light display system of claim 45 wherein the curved mirror comprises an aperture for allowing light emitted from the excitation source to be transmitted therethrough.

47. The scanned light display system of claim 44 wherein the excitation light source comprises at least one of a violet light source and an ultraviolet light source.

48. The scanned light display system of claim 36 wherein the curved mirror comprises a spherical mirror.

49. The scanned light display system of claim 36 wherein the curved mirror comprises a Fresnel mirror.

50. The scanned light display system of claim 36 wherein the curved mirror comprises a diffractive mirror.

51. The scanned light display system of claim 36 wherein the curved mirror is maintained substantially stationary and the actuator is operable to move the pixel source.

52. The scanned light display system of claim 36 wherein the pixel source is maintained substantially stationary and the second actuator is operable to move the curved mirror.

53. The scanned light display system of claim 36 wherein the pixel source comprises a plurality of pixel sources and wherein the first actuator is operable to move the plurality of pixel sources in a manner that maintains the distance between the plurality of pixel sources and the curved mirror substantially constant as the second actuator moves the plurality of pixel sources to scan the received light to form the image.

54. The scanned light display system of claim 36 wherein the pixel source comprises a substantially linear array of light emitters.

55. The scanned light display system of claim 36 wherein the pixel source comprises a substantially linear array of portions of photoluminescent material.

56. The scanned light display system of claim 36 wherein the curved mirror is at least partially transparent.

57. The scanned light display system of claim 36 wherein the image is an image frame and wherein the pixel source provides pixels having different respective apparent depths in the image frame.

58. The scanned light display system of claim 36 wherein the first actuator includes at least one cantilever beam having the pixel source located adjacent an end thereof, and the at least one cantilever beam is configured to be deflected in the direction toward the curved mirror and away from the curved mirror.

59. The scanned light display system of claim 58 wherein the first actuator is operable to deflect the at least one cantilevered beam using an electrostatic force.

60. The scanned light display system of claim 36 wherein the pixel source comprises a plurality of pixel sources and wherein the first actuator includes a plurality of cantilever beams, each of the cantilever beams having one of the pixel sources located adjacent an end thereof, and each of the cantilever beams configured to be deflected in the direction toward the curved mirror and away from the curved mirror.

61. The scanned light display system of claim 60 wherein the first actuator is operable to deflect each of the cantilevered beams using an electrostatic force.

62. The scanned light display system of claim 36, further comprising a controller coupled to the pixel source and the first and second actuators, the controller being operable to couple signals to the pixel source and the first and second actuators.

63. The scanned light display system of claim 62, further comprising an image capture system.

64. The scanned light display system of claim 62, further comprising an image generation system and wherein the controller is operable to scan the light provided by the pixel source to provide the image responsive to a signal from the image generation system.

65. The scanned light display system of claim 64 wherein the image generation system comprises one of a video gaming system, a digital camera, a recorded media player, and a television receiver.

66. The scanned light display system of claim 1 wherein the pixel source comprises one of a surface-emitting light emitting diode (LED), an organic LED, an edge emitting LED, a laser diode, a liquid crystal display panel, a diode-pumped solid state laser, a photoluminescent material, a reflector, and a fiber-optic source.

67. A method of varying the apparent depth of pixels in an image, the method comprising:
providing light from a pixel source at a first position;
reflecting the light provided from the pixel source at the first position from a curved reflecting surface;
relatively moving the pixel source and the curved mirror in at least one of a direction toward the curved reflecting surface and away from the curved reflecting surface to a second position;
providing light from the pixel source while the pixel source is at the second position; and
reflecting the light provided from the pixel source at the second position from the curved reflecting surface.

68. The method of claim 67 wherein the pixel source comprises a plurality of pixel sources.

69. The method of claim 68 wherein each of the plurality of pixel sources comprises at least one light emitter.

70. The method of claim 68 wherein each of the plurality of pixel sources comprises at least one portion of photoluminescent material.

71. The method of claim 67, further comprising scanning the light provided from the pixel source to form the image.

72. The method of claim 71 wherein act of scanning the light provided from the pixel source to define the image comprises relatively moving the curved reflecting surface and the pixel source.

73. A display system for providing an image, comprising:
a collimating element configured to at least partially collimate light;
a plurality of pixels sources, each of the pixel sources corresponding to a pixel of the image; and
an actuator operable to relatively move the plurality of pixel sources and the collimating element in at least one of a direction toward each other and a direction away from each other so that light provided by the pixel source is at least partially collimated by the collimating element to different extents depending upon the location of the pixel source to provide pixels having different apparent depths in the image.

74. The display system of claim 73 wherein at least one of the plurality of pixel sources is operable to be electrically addressed.

75. The display system of claim 73 wherein each of the pixel sources comprises at least one light emitter.

76. The display system of claim 73 wherein at least one of the plurality of pixel sources is operable to be optically addressed.

77. The display system of claim 76 wherein the each of the pixel sources comprises at least one portion of photoluminescent material.

78. The display system of claim 77 wherein the at least one portion of photoluminescent material comprises one of an up-converting photoluminescent material and a down converting photoluminescent material.

79. The display system of claim 78 wherein the at least one portion of photoluminescent material comprises at least one of coumarin, fluorescein, rhodamine, neodimium doped yttrium aluminum Garnet (Nd:YAG), Y₃Al₅O₂:Nd, zinc sulfide doped with copper (ZnS:Cu), zinc sulfide doped with aluminum (ZnS:Al), yttrium oxysulfide doped with europium (Y₂O₂S:Eu), a solvated fluorescent material, photoluminescent particles dispersed in a polymer matrix, a fluorescing ion in a glass medium, a short chain organic dye in a polymer medium, and a long chain organic dye.

80. The display system of claim 77, further comprising an excitation light source and a scanner operable to scan light emitted from the excitation light source in a manner to selectively irradiate each of the photoluminescent materials of the pixel sources.

81. The display system of claim 80 wherein the excitation light source comprises at least one of a violet light source and an ultraviolet light source.

82. The display system of claim 73 wherein the collimating element comprises a curved mirror.

83. The display system of claim 73 wherein the curved mirror comprises a spherical mirror.

84. The display system of claim 83 wherein the curved mirror comprises a Fresnel mirror.

85. The display system of claim 83 wherein the curved mirror comprises a diffractive mirror.

86. The display system of claim 73 wherein the collimating element comprises a curved mirror that is at least partially transparent.

87. The display system of claim 73 wherein the image is an image frame and wherein the plurality of pixel sources provides pixels having different respective apparent depths in the image frame.

88. The display system of claim 73 wherein the actuator includes a plurality of cantilever beams, each of the cantilever beams having one of the pixel sources located adjacent an end thereof, and each of the cantilever beams configured to be deflected in the direction toward the collimating element and away from the collimating.

89. The display system of claim 88 wherein the actuator is operable to deflect each of the cantilevered beams using an electrostatic force.

90. The display system of claim 73, further comprising a controller coupled to the pixel sources and the actuator, the controller being operable to couple signals to the pixel sources and the actuator.

91. The display system of claim 88, further comprising an image capture system.

92. The display system of claim 88, further comprising an image generation system and wherein the controller is operable to scan the light provided by the pixel sources to provide the image responsive to a signal from the image generation system.

93. The display system of claim 92 wherein the image generation system comprises one of a video gaming system, a digital camera, a recorded media player, and a television receiver.

94. The scanned light display system of claim 73 wherein each of the pixel sources comprises one of a surface-emitting light emitting diode (LED), an organic LED, an edge emitting LED, a laser diode, a liquid crystal display panel, a diode-pumped solid state laser, a photoluminescent material, a reflector, and a fiber-optic source.

95. A method of varying the apparent depth of pixels in an image, the method comprising:
providing light from a plurality of pixel sources;
at least partially collimating the light provided from each of the pixel sources using an optical element; and
selectively moving at least one of the pixel sources in at least one of a direction toward and away from the optical element to vary the extent of collimation of light provided therefrom.

96. The method of claim 94 wherein the act of selectively moving at least one of the pixel sources in at least one of a direction comprises deflecting a beam bearing the at least one of the pixel sources in the at least one direction.

97. The method of claim 94 wherein the act of deflecting a beam comprises electrostatically deflecting the beam.

98. The method of claim 94 wherein each of the pixel sources comprises at least one light emitter.

99. The method of claim 94 wherein each of the pixel sources comprises at least one portion of photoluminescent material.
